(19) United States
(12) Patent Application Publication
(10) Pub. No.: US 2012/0047824 A1
(43) Pub. Date: Mar. 1, 2012

(54) TRANSPARENT CANOPY HAVING THIN FILM SOLAR CELLS AND CAPABLE OF INSECTS PREVENTION

(75) Inventors: YEE SHYI CHANG, TAIPEI 106 (TW); CHANG CHI MEI, TAIPEI 106 (TW); CHI-JEN LIU, TAIPEI 106 (TW)

(73) Assignee: AN CHING NEW ENERGY MACHINERY & EQUIPMENT CO., LTD., TAIPEI 106 (TW)

(21) Appl. No.: 13/017,371

(22) Filed: Jan. 31, 2011

(30) Foreign Application Priority Data
Aug. 24, 2010 (TW) 99128291

(51) Int. Cl. E04D 13/18; F21V 33/00

(52) U.S. Cl. 52/173.3; 362/234

(57) ABSTRACT

A transparent building, comprising a building body and at least a thin film solar cell. Said building body has a top portion, and said thin film solar cell is arranged on said top portion of said building body. Said thin film solar cell absorbs green light, blue light, and ultraviolet light in sunlight, and converts them into electrical energy, and also allows red light, orange light, yellow light, and infrared light to pass through said thin film solar cell and reach inside of said building body. A transparent canopy having said thin film solar cell is also disclosed.

### BACKGROUND OF THE INVENTION

1. Field of the Invention

The present invention relates to a building or canopy, and in particular to a transparent building and transparent canopy having solar cell and capable of insects prevention.

2. The Prior Arts

Among numerous technologies of alternative energy resources and regenerated energy resources, solar cell is the most promising and getting most of the attention. The main reasons for this is that, solar cell is capable of converting solar energy directly into electrical energy, and it does not produce detrimental materials such as carbon dioxide or nitride, thus it does not cause pollution to the environment. Among various types of solar cells, the thin film solar cell has the best potential for further development due to its advantages of lower manufacturing cost.

In general, structure of a conventional thin film solar cell has a substrate sequentially stacked thereon with an electrode layer, a photovoltaic layer, and an electrode layer. When light irradiates on a thin film solar cell, atoms in the photovoltaic layer are agitated to produce pairs of free electrons and holes, and through an internal electrical field formed by a PN junction, electrons and holes tend to move toward two electrode layers, thus producing a potential difference for a state of electrical energy storage. Meanwhile, if an external circuit or electronic device is connected, then, the thin film solar cell is able to output electricity to drive the external circuit or electronic device into performing the actions required. However, presently, there still lacks a kind of building or canopy provided with solar cell and capable of insect prevention.

### SUMMARY OF THE INVENTION

In view of the problems and shortcomings of the prior art, the present invention provides a transparent building and a transparent canopy having solar cell on its top, and capable of insects prevention, better illumination, and power saving.

The present invention provides a transparent building and a transparent canopy, with it top portion provided with thin film solar cells, and having effects of good lighting, insects prevention, and power saving.

The present invention provides a transparent building, comprising a building body, and at least a thin film solar cell. The building body is provided with a top portion, and the thin film solar cell is arranged on the top portion of the building body. The thin film solar cell absorbs green light, blue light, and ultraviolet light in the sunlight and converts them into electrical energy, and the red light, orange light, yellow light, and infrared light in the sunlight pass through the thin film solar cell and reach inside the building body.

In an embodiment of the present invention, at least a thin film solar cell is a transparent solar cell, and at least a thin film solar cell is placed on the top portion of the building body.

In another embodiment of the present invention, the building body can serve as a fruit and vegetable wholesale market or an agricultural canopy.

In a yet another embodiment of the present invention, the transparent building further includes at least a light-emitting-diode, arranged on the top portion of the building for providing illumination light beams irradiating inside of the building. At least a thin film solar cell is connected electrically to at least a light-emitting-diode, and the electrical energy converted by at least a thin film solar cell is supplied to at least a light-emitting-diode.

In a further embodiment of the present invention, the illumination light beam provided by the light-emitting-diode includes red light, orange light, or yellow light.

In another embodiment of the present invention, the illumination light beam provided by the light-emitting-diode does not include violet light or ultraviolet light.

The present invention further provides a transparent canopy having thin film solar cells, including a canopy frame, canopy top, and at least a thin film solar cell. The canopy top is installed on the canopy frame in defining an accommodation space. The thin film solar cell is arranged in the canopy top of the canopy frame, and the thin film solar cell is able to absorb green light, blue light, and ultraviolet light in the sunlight and convert them into electrical energy. Red light, orange light, yellow light, and infrared light pass through the thin film solar cell and reach the accommodation space.

In a yet another embodiment of the present invention, at least a thin film solar cell can be a part of canopy top.

In a still another embodiment of the present invention, the transparent canopy includes at least a light-emitting-diode, arranged at canopy top and provides illumination light beam irradiating the accommodation space. The thin film solar cell is connected electrically to the light-emitting-diode, and the electrical energy converted by the thin film solar cell is supplied to the light-emitting-diode.

In a further embodiment of the present invention, at least a thin film solar cell is a transparent solar cell.

In the transparent building of the present invention, thin film solar cell is arranged on the top portion of building body, so that when sunlight irradiates onto this top portion, the thin film solar cell will absorb green light, blue light, and ultraviolet light in the sunlight, and convert them into electric energy for supplying it to the transparent building. In addition, red light, orange light, yellow light, and infrared light will pass through the thin film solar cell and reach inside the building body, for the indoor illumination of the transparent building.

Since the sunlight reaching inside the building body is devoid of violet and ultraviolet lights for being absorbed by thin film solar cell, thus preventing insects and mosquitoes from being induced into the building body. In other words, the transparent building has the advantages of raising its internal illumination and brightness, while preventing entering of insects and mosquitoes. In addition, the present invention also provides a transparent canopy adopting the design concepts mentioned above.

Further scope of applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The related drawings in connection with the detailed description of the present invention to be made later are described briefly as follows, in which:

FIG. 1 is a schematic diagram of a transparent building according to an embodiment of the present invention;

FIG. 2 is a schematic diagram of a transparent building according to another embodiment of the present invention; and

FIG. 3 is a schematic diagram of a transparent canopy according to yet another embodiment of the present invention.

### DETAILED DESCRIPTION OF THE PREFERRED EMBODIMENT

The purpose, construction, features, functions and advantages of the present invention can be appreciated and understood more thoroughly through the following detailed description with reference to the attached drawings. And, in the following, various embodiments are described in explaining the technical characteristics of the present invention.

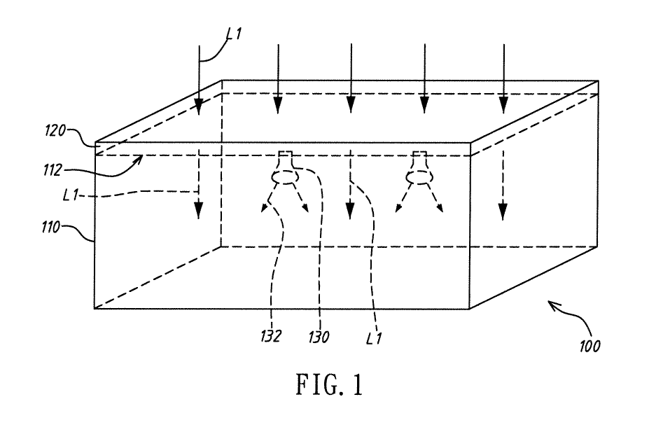

Refer to FIG. 1 for a schematic diagram of a transparent building according to an embodiment of the present invention. As shown in FIG. 1, the transparent building 100 of the present embodiment includes a building body 110 and at least a thin film solar cell 120. The building body 110 is provided with a top portion 112, and thin film solar cell 120 is arranged at the top portion 112 of the building body 110. To be more specific, the major characteristic of the thin film solar cell 120 of the present embodiment is that, when sunlight L1 irradiates onto the top portion 112 of a building body 110, the thin film solar cell 120 at the top portion 112 will absorb green light, blue light, and ultraviolet light in the sunlight L1, and convert them into electrical energy. In addition, red light, orange light, yellow light, and infrared light in the sunlight L1 will pass through the thin film solar cell 120 and reach inside of the building body 110, as shown in FIG. 1. In other words, in the present embodiment, the thin film solar cell 120 can be a transparent solar cell, such that red light, orange light, yellow light, and infrared light in the sunlight L1 are apt to pass through the thin film solar cell 120; while green light, blue light, and ultraviolet light in the sunlight L1 are apt to be absorbed by the thin film solar cell 120 or be reflected.

In the present embodiment, the building body 110 mentioned above can be a fruit and vegetable wholesale market or an agricultural canopy. To be more specific, the conventional fruit and vegetable wholesale market occupies a fairly large area and its illumination inside is poor and insufficient. In addition, usually, the fruit and vegetable wholesale market utilizes light bulbs for illumination, and the poor illumination causes the vegetable vender inconvenience in determining counterfeit money during transaction, and the ultraviolet light it emits tend to induce insects and mosquitoes, that is the reason why conventional fruit and vegetable wholesale market is liable to be infested with insects and mosquitoes.

For the above reasons, in case that the fruit and vegetable wholesale market adopts the design of the present embodiment, namely, the top portion 112 of the building body 110 (such as the fruit and vegetable wholesale market) is arranged with a transparent thin film solar cell 120, then in sunny weather and broad daylight, the sunlight L1 passing through the transparent thin film solar cell 120 can provide sufficient internal illumination for the building body 110, and since the sunlight L1 reaching inside the building body 110 is devoid of violet and ultraviolet lights for being absorbed by thin film solar cell 120, thus preventing insects and mosquitoes from being induced into the building body 110. In other words, the fruit and vegetable wholesale market adopting the design concept of the present embodiment will have the advantages of increased internal illumination and brightness, while preventing entering of insects and mosquitoes.

In the present embodiment, the transparent building 100 further includes at least a light-emitting-diode 130, arranged at the top portion 112 of building 110, and provides illumination light beams 132 for internal illumination of building body 110, as shown in FIG. 1. To be more specific, in the present embodiment, the light-emitting-diode 130 is used to replace the conventional light bulb, such that in addition to the advantages of reducing electricity utilized, it can avoid effectively inducing insects or mosquitoes into the building body 110, since the illumination light beam 132 provided by the light-emitting-diode 130 does not contain violet or ultraviolet light. In an embodiment, the illumination light beam 132 provided by the light-emitting-diode 130 includes red light, orange light, or yellow light.

Moreover, the thin film solar cell 120 is connected electrically to the light-emitting-diode 130, therefore, light-emitting-diode 130 is able to use the electrical energy converted and provided by the thin film solar cell 120. To be more specific, when in sunny weather and broad daylight, the portion of sunlight L1 passing through the transparent thin film solar cells 120 can be used for internal illumination of a building body 110; and while in cloudy weather or at night, the light-emitting-diodes 130 can provide enough illumination inside the building body 110. As to the power required for the light-emitting-diodes 130, in addition to the ordinary local power supply, the stored electrical energy as converted by the thin film solar cell 120 can also be utilized, thus saving expense spent on electricity and achieving energy conservation.

It must be mentioned that, in the transparent building 100, the top portion of building body is made of transparent material, and the thin film solar cell is arranged on this top portion, as shown in FIG. 1.

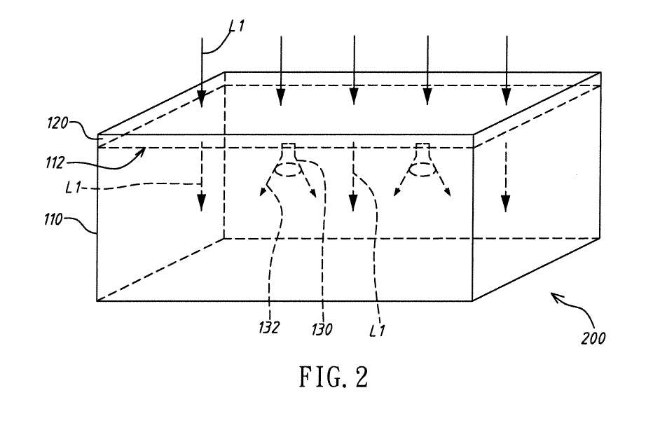

Refer to FIG. 2 for a schematic diagram of a transparent building according to another embodiment of the present invention, also refer to FIG. 1. As shown in FIGS. 1 & 2, the concept of design of transparent building 200 is similar to that of transparent building 100, however, the difference is that, as shown in FIG. 2, the top portion 112 of building body 110 of the transparent building 200 utilizes directly the thin film solar cell 120 as its top portion. In other words, the thin film solar cell 120 is a part of building body 110 itself, namely, the thin film solar cell 120 is integrated into the building body 110 as the top portion 112 of building body 110.

As mentioned above, the design concept of the transparent building 200 is similar to that of the transparent building 100, therefore, the advantages of the transparent building 200 is similar to that of the transparent building 100, and it will not be repeated here for brevity.

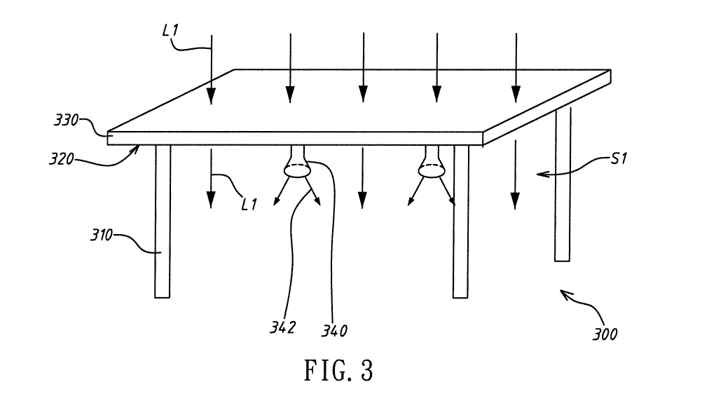

Refer to FIG. 3 for a schematic diagram of a transparent canopy according to yet another embodiment of the present invention. As shown in FIG. 3, the transparent canopy 300 includes a canopy frame 310, a canopy top 320, and at least a thin film solar cell 330. The canopy top 320 is installed on the canopy frame 310 in defining an accommodation space S1, as shown in FIG. 3. The thin film solar cell 330 is arranged on the canopy top 320 of the canopy frame 310. To be more specific, in the present embodiment, the major characteristic of the thin film solar cell 330 is that, when sunlight L1 irradiates onto the canopy top 320, the thin film solar cell 330 located in the canopy top 320 will absorb green light, blue light, and ultraviolet light in sunlight L1, and convert them into electrical energy. In addition, red light, orange light, yellow light, and infrared light will pass through the thin film solar cell 330 and reach the accommodation space S1, as shown in FIG. 3. In other words, in the present embodiment, the thin film solar cell 330 can be a transparent solar cell, such that, red light, orange light, yellow light, and infrared light are apt to pass through the thin film solar cell 330, while green light, blue light, and ultraviolet light are apt to be absorbed or reflected by the thin film solar cell 330.

In the present embodiment, the transparent canopy 300 is applicable to a fruit and vegetable wholesale market or an agricultural canopy. To be more specific, in a fruit and vegetable wholesale market adopting the design concept of the present embodiment, namely, if the canopy top 320 of the transparent canopy 300 is arranged with the transparent thin film solar cell 330, then in sunny weather and broad daylight, the red light, orange light, yellow light, and infrared light passing through the transparent thin film solar cell 330 can be used for illumination of the inside (namely, the accommodation space S1) of the transparent canopy 300. Since the sunlight L1 reaching inside the transparent canopy 300 is devoid of violet or ultraviolet light for being absorbed by thin film solar cell 330, thus preventing insects from being induced into the transparent canopy 300. In other words, the fruit and vegetable wholesale market adopting design concept of the present embodiment will have the advantages of increased internal illumination and brightness, while preventing entering of insects and mosquitoes.

In the present embodiment, the transparent canopy 300 may further be provided with at least a light-emitting-diode 340 arranged on the canopy top 320, in providing illumination light beam 342 for the illumination of the accommodation space 51. To be more specific, the light-emitting-diode 340 is used to replace the conventional light bulb, such that in addition to the advantages of reducing electricity utilized, it is able to prevent effectively entering of insects or mosquitoes into the accommodation space S1, since the illumination light beam 342 provided by the light-emitting-diode 340 does not contain violet or ultraviolet light. In an embodiment, the illumination light beam 342 provided by the light-emitting-diode 340 includes red light, orange light, or yellow light.

Moreover, light-emitting-diode 340 is connected electrically to the thin film solar cell 330, therefore, light-emitting-diode 340 is able to use the electrical energy converted and provided by the thin film solar cell 330. To be more specific, when in sunny weather and broad daylight, the portion of sunlight L1 passing through the transparent thin film solar cells 330 can be used for internal illumination of a transparent canopy 300; and while in cloudy weather or at night, the light-emitting-diodes 340 can provide sufficient illumination inside the transparent canopy 300. As to the power required for the light-emitting-diodes 340, in addition to the ordinary local power supply, the stored electrical energy as converted by the thin film solar cell 120 can also be utilized, thus saving expense spent on electricity and achieving energy conservation and carbon reduction.

It has to be mentioned that, in the transparent canopy 300, the canopy top 320 can be made of transparent material, while the thin film solar cell 330 is arranged on the canopy top 320, as shown in FIG. 3. In another embodiment not shown, the thin film solar cell 330 can also be a part of canopy top 320, namely, the thin film solar cell 330 is used as the canopy top 320 of transparent canopy 300, and the canopy frame 310 is used to support the thin film solar cell 330.

Summing up the above, the transparent building of the present invention has the following advantages: firstly, thin film solar cells are arranged on the top portion of the building body, such that when sunlight irradiates onto the top portion of the building, the thin film solar cells absorb the green light, blue light, and ultraviolet light in the sunlight, and convert them into electrical energy for use by the transparent building; secondly, red light, orange light, yellow light, and infrared light passing through the thin film solar cell will reach inside the building body to provide the illumination required; thirdly, since the sunlight reaching inside the building body is devoid of violet or ultraviolet light for being absorbed by thin film solar cell, thus preventing insects and mosquitoes from being induced into the building body. In other words, the transparent building of the present embodiment has the advantages of raised internal illumination and brightness, while preventing entering of insects and mosquitoes. In addition, the present invention also provides a transparent canopy adopting the design concepts mentioned above.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A transparent building having a transparent top portion, comprising:
a building body, having a top portion; and
at least a thin film solar cell, arranged on said top portion of said building body, and is capable of absorbing green light, blue light, and ultraviolet light, and converting them into electrical energy, and allowing red light, orange light, yellow light, and infrared light to pass through and reach inside said building body.

2. The transparent building having a transparent top portion as claimed in claim 1, wherein said at least a thin film solar cell is a transparent solar cell, and is used as said top portion of said building body.

3. The transparent building having a transparent top portion as claimed in claim 1, wherein said building body is a fruit and vegetable wholesale market or an agricultural canopy.

4. The transparent building having a transparent top portion as claimed in claim 1, further comprising: at least a light-emitting-diode, arranged at said top portion of said building body, and provides illumination light beam irradiating inside said building body, said at least a light-emitting-diode is connected electrically to said at least a thin film solar cell, and electrical energy converted and obtained through said at least a thin film solar cell is supplied to said at least a light-emitting-diode.

5. The transparent building having transparent top portion as claimed in claim 4, wherein said illumination light beam provided by said light-emitting-diode includes red light, orange light, or yellow light.

6. The transparent building having transparent top portion as claimed in claim 1, wherein said illumination light beam provided by said light-emitting-diode does not include violet or ultraviolet light.

7. A transparent canopy having thin film solar cell, comprising:
a canopy frame;
a canopy top, disposed on said canopy frame and defines an accommodation space; and
at least a thin film solar cell, arranged in said canopy top of said canopy frame, said at least a thin film solar cell absorbs green light, blue light, and ultraviolet light and converts them into electrical energy, and allows red light, orange light, yellow light, and infrared light to pass through and reach said accommodation space.

8. The transparent canopy having thin film solar cell as claimed in claim 7, wherein said at least a thin film solar cell is a transparent solar cell.

9. The transparent canopy having thin film solar cell as claimed in claim 7, wherein said at least a thin film solar cell is used as a part of said canopy top.

10. The transparent canopy having thin film solar cell as claimed in claim 7, further comprising: at least a light-emitting-diode, arranged on said canopy top, and provides illumination light beam irradiating inside said accommodation space, said at least a light-emitting-diode is connected electrically to said at least a thin film solar cell, and electrical energy converted and obtained through said at least a thin film solar cell is supplied to said at least a light-emitting-diode.
